(19) United States
(12) Patent Application Publication
(10) Pub. No.: US 2017/0164693 A1
(43) Pub. Date: Jun. 15, 2017

(54) Safety Belt Buckle with Reinforced Structure

(71) Applicant: Taiwan Racing Products Co., Ltd., Changhua County (TW)

(72) Inventor: Wen-Yuan Wu, Changhua County (TW)

(21) Appl. No.: 14/969,091

(22) Filed: Dec. 15, 2015

(51) Int. Cl. A44B 11/25; B60R 22/18

(52) U.S. Cl. CPC A44B 11/2542; B60R 22/18; A44B 11/2549; B60R 2022/1806

(57) ABSTRACT

A safety belt buckle includes a base unit, an annular block mounted on the base unit, a cover covering the base unit, a locking device mounted in the cover, and a rotary driving unit mounted on the cover. Thus, the annular block made of metallic material is combined with the base unit to reinforce the whole strength of the base unit.

### BACKGROUND OF THE INVENTION

1. Field of the Invention

The present invention relates to a safety belt buckle and, more particularly, to a safety belt buckle for a car.

2. Description of the Related Art

A conventional safety belt latch comprises a buckle and a plurality of latch plates. The buckle includes a top cover, a bottom cover juxtaposed to and combined with the top cover, a plurality of slots defined between the top cover and the bottom cover, a locking device mounted between the top cover and the bottom cover, and a control switch rotatably mounted on the top of the top cover. Each of the latch plates has a first end connected with a safety belt and a second end provided with a tongue having a locking hole. When the tongue of one of the latch plates is inserted into one of the slots of the buckle, the locking hole of the tongue is locked by the locking device so that one of the latch plates is locked by the buckle. When the control switch is rotated, the locking hole of the tongue is unlocked from the locking device so that one of the latch plates is unlocked from and can be detached from the buckle.

### BRIEF SUMMARY OF THE INVENTION

The primary objective of the present invention is to provide a safety belt buckle with a reinforced structure.

In accordance with the present invention, there is provided a safety belt buckle comprising a base unit, an annular block mounted on the base unit, a cover covering the base unit, a locking device mounted in the cover, and a rotary driving unit mounted on the cover. The base unit includes a support base having a top provided with a plurality of slideways and a bottom provided with an annular groove, and a plurality of elastic modules mounted in the slideways. The top of the support base has a center provided with a recessed flange, and each of the slideways extends from the recessed flange to a periphery of the support base. The slideways of the support base are arranged in a radiating manner. The support base is provided with a plurality of abutting pieces surrounding the recessed flange. The periphery of the support base is provided with a plurality of spacing blocks and a plurality of insertion slots located between the spacing blocks. The annular block is mounted in the annular groove of the support base. The cover a top provided with a mounting depression and a bottom provided with a receiving space. The top of the cover has a center provided with a shaft hole connected to the receiving space. The receiving space of the cover is provided with a plurality of convex portions, a plurality of concave portions located between the convex portions, and a plurality of pillars located in the concave portions. The locking device is mounted in the receiving space of the cover and includes a fixed post mounted on one of the pillars of the cover, a plurality of movable posts mounted on the pillars of the cover and corresponding to the elastic modules of the base unit, a plurality of springs mounted on the pillars of the cover and located in the fixed post and the movable posts, a conical spring mounted in the receiving space of the cover and corresponding to the shaft hole of the cover, a driven plate mounted in the receiving space of the cover and abutting the conical spring, a central rotation shaft mounted on the cover, and a fixed disk arranged under the driven plate and abutting the spacing blocks of the support base. The driven plate of the locking device has a central portion provided with a through hole and a hollow lug and has a rim provided with a plurality of clamping grooves. The hollow lug of the driven plate has a notch. The central rotation shaft of the locking device includes a shaft shank extending through the through hole of the driven plate and provided with a pivot hole, and a pin extending through the pivot hole of the shaft shank and abutting the hollow lug of the driven plate. The fixed disk of the locking device has a central portion provided with a retaining hole to allow insertion of the abutting pieces of the support base. The fixed disk of the locking device has a periphery provided with a plurality of passages corresponding to the slideways of the support base. The fixed disk of the locking device has a rim provided with a plurality of openings. The fixed post and the movable posts f the locking device extends through the passages of the fixed disk and are clamped in the clamping grooves of the driven plate. The fixed post of the locking device has an end provided with an interior hole for mounting one of the springs. Each of the movable posts of the locking device has an end provided with an interior hole for mounting one of the springs. The rotary driving unit is partially received in the mounting depression of the cover and includes a circular cap having a bottom center provided with a mounting recess mounted on the central rotation shaft of the locking device, and a drive handle extending from the circular cap.

According to the primary advantage of the present invention, the annular block made of metallic material is combined with the base unit to reinforce the whole strength of the base unit, thereby enhancing the safety of using the safety belt buckle.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a safety belt buckle in accordance with the preferred embodiment of the present invention.

FIG. 2 is an exploded perspective view of the safety belt buckle as shown in FIG. 1.

FIG. 3 is another exploded perspective view of the safety belt buckle as shown in FIG. 1.

FIG. 4 is a cross-sectional view of the safety belt buckle as shown in FIG. 1.

FIG. 5 is a schematic operational view of the safety belt buckle for a safety belt as shown in FIG. 1 in use.

FIG. 6 is a cross-sectional assembly view of the safety belt buckle and the safety belt as shown in FIG. 5.

FIG. 7 is a top operational view showing release of the safety belt.

FIG. 8 is a cross-sectional operational view showing release of the safety belt.

### DETAILED DESCRIPTION OF THE INVENTION

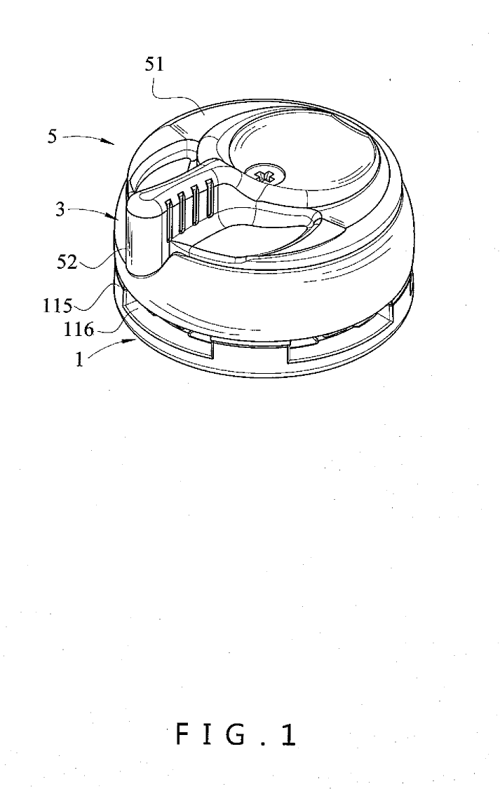

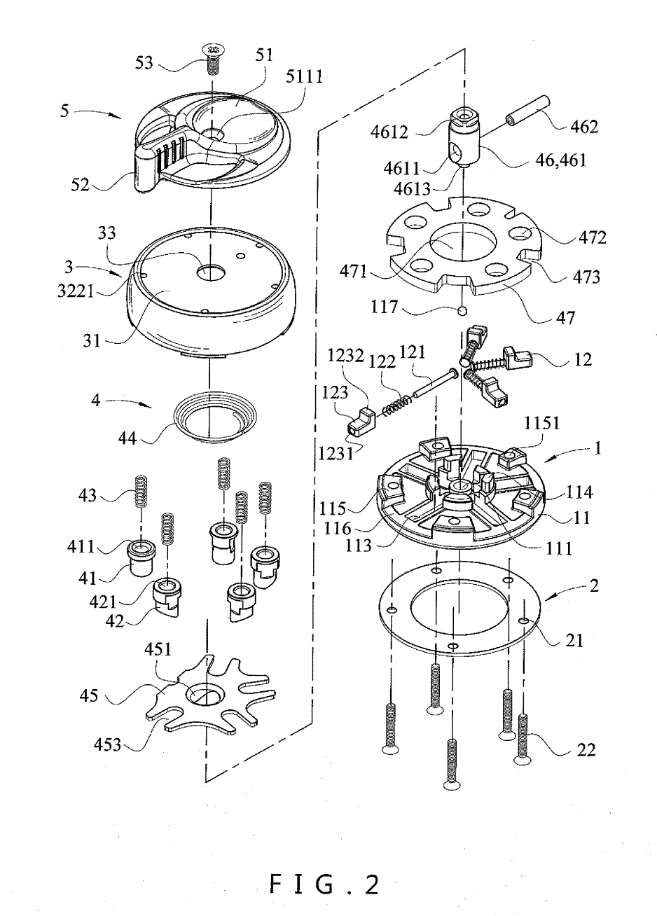

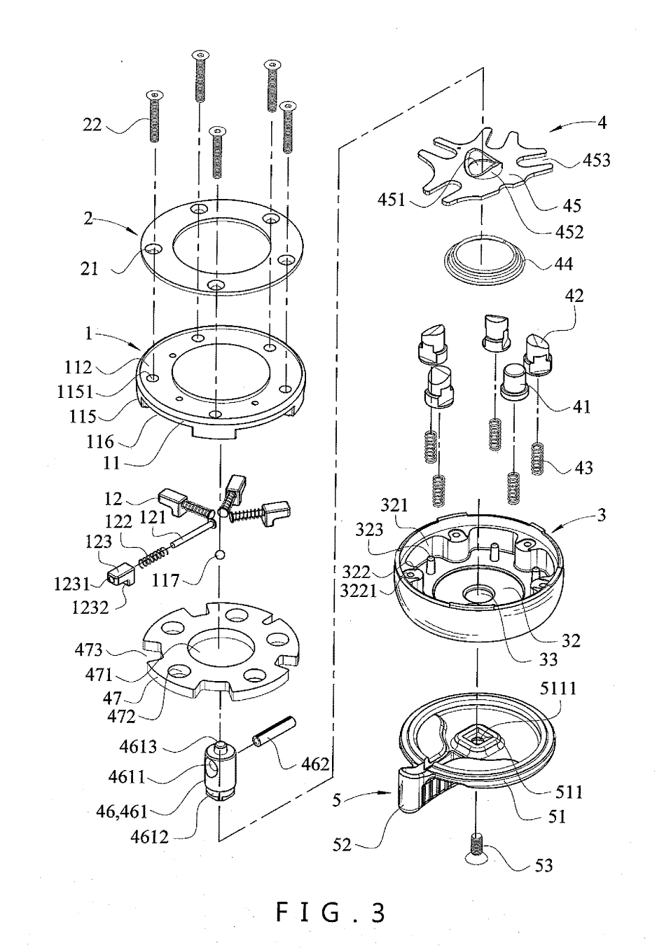

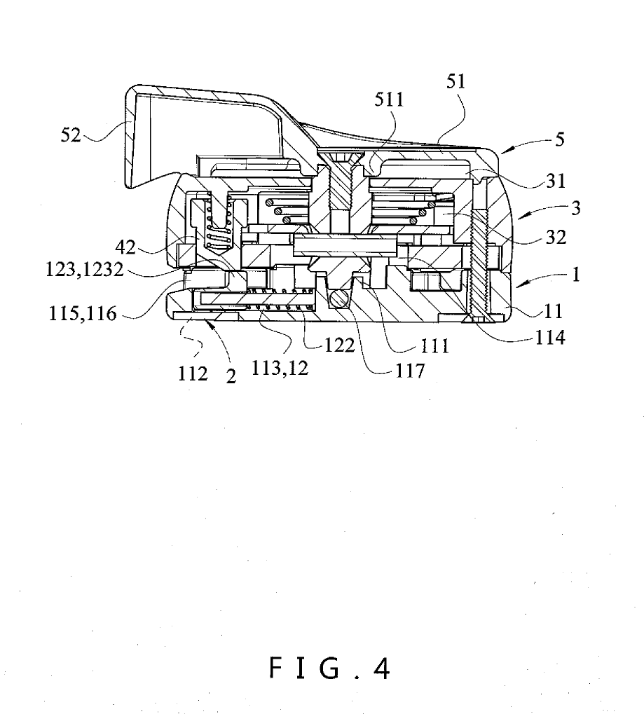

Referring to the drawings and initially to FIGS. 1-4, a safety belt buckle in accordance with the preferred embodiment of the present invention comprises a base unit 1, an annular block 2 mounted on the base unit 1, a cover 3 covering the base unit 1, a locking device 4 mounted in the cover 3, and a rotary driving unit 5 mounted on the cover 3.

The base unit 1 includes a support base 11 having a top provided with a plurality of slideways 113 and a bottom provided with an annular groove 112, and a plurality of elastic modules 12 mounted in the slideways 113. The top of the support base 11 has a center provided with a recessed flange 111, and each of the slideways 113 extends from the recessed flange 111 to a periphery of the support base 11. The slideways 113 of the support base 11 are arranged in a radiating manner. The support base 11 is provided with a plurality of abutting pieces 114 surrounding the recessed flange 111 and arranged in a semi-circular manner. The periphery of the support base 11 is provided with a plurality of spacing blocks 115 and a plurality of insertion slots 116 located between the spacing blocks 115. The spacing blocks 115 of the support base 11 are arranged in a radiating manner.

The annular block 2 is mounted in the annular groove 112 of the support base 11.

The cover 3 a top provided with a mounting depression 31 and a bottom provided with a receiving space 32. The top of the cover 3 has a center provided with a shaft hole 33 connected to the receiving space 32. The receiving space 32 of the cover 3 is provided with a plurality of convex portions 322, a plurality of concave portions 321 located between the convex portions 322, and a plurality of pillars 323 located in the concave portions 321. Thus, the receiving space 32 of the cover 3 presents a star-shaped profile.

The locking device 4 is mounted in the receiving space 32 of the cover 3 and includes a fixed post 41 mounted on one of the pillars 323 of the cover 3, a plurality of movable posts 42 mounted on the pillars 323 of the cover 3 and corresponding to the elastic modules 12 of the base unit 1, a plurality of springs 43 mounted on the pillars 323 of the cover 3 and located in the fixed post 41 and the movable posts 42, a conical spring 44 mounted in the receiving space 32 of the cover 3 and corresponding to the shaft hole 33 of the cover 3, a driven plate 45 mounted in the receiving space 32 of the cover 3 and abutting the conical spring 44, a central rotation shaft 46 mounted on the cover 3, and a fixed disk 47 arranged under the driven plate 45 and abutting the spacing blocks 115 of the support base 11. The driven plate 45 of the locking device 4 has a central portion provided with a through hole 451 and a hollow lug 452 and has a rim provided with a plurality of clamping grooves 453. The hollow lug 452 of the driven plate 45 has a notch. The central rotation shaft 46 of the locking device 4 includes a shaft shank 461 extending through the through hole 451 of the driven plate 45 and provided with a pivot hole 4611, and a pin 462 extending through the pivot hole 4611 of the shaft shank 461 and abutting the hollow lug 452 of the driven plate 45. The fixed disk 47 of the locking device 4 has a central portion provided with a retaining hole 471 to allow insertion of the abutting pieces 114 of the support base 11 so as to position the fixed disk 47. The fixed disk 47 of the locking device 4 has a periphery provided with a plurality of passages 472 corresponding to the slideways 113 of the support base 11. The fixed disk 47 of the locking device 4 has a rim provided with a plurality of openings 473. The fixed post 41 and the movable posts 42 of the locking device 4 extends through the passages 472 of the fixed disk 47 and are clamped in the clamping grooves 453 of the driven plate 45. The fixed post 41 of the locking device 4 has an end provided with an interior hole 411 for mounting one of the springs 43. Each of the movable posts 42 of the locking device 4 has an end provided with an interior hole 421 for mounting one of the springs 43. The conical spring 44 of the locking device 4 abuts a top of the receiving space 32 of the cover 3.

The rotary driving unit 5 is partially received in the mounting depression 31 of the cover 3 and includes a circular cap 51 having a bottom center provided with a mounting recess 511 mounted on the central rotation shaft 46 of the locking device 4, and a drive handle 52 extending from the circular cap 51.

In the preferred embodiment of the present invention, the support base 11 has five slideways 113, the base unit 1 includes four elastic modules 12, and the locking device 4 includes four movable posts 42.

In the preferred embodiment of the present invention, each of the elastic modules 12 of the base unit 1 includes a push rod 121, a slide 123 mounted on the push rod 121 and having a side provided with a stop 1232 pressing one of the movable posts 42, and a spring 122 mounted on the push rod 121 and biased between the push rod 121 and the slide 123. The slide 123 of each of the elastic modules 12 is provided with an aperture 1231 mounted on the push rod 121.

In the preferred embodiment of the present invention, the base unit 1, the annular block 2 and the cover 3 are combined by screwing. Each of the spacing blocks 115 of the support base 11 is provided with a first bore 1151, the annular block 2 is provided with a plurality of second bores 21, each of the convex portions 322 of the cover 3 is provided with a locking bore 3221, and the safety belt buckle further comprises a plurality of fastener members 22 each extending through each of the second bores 21 of the annular block 2 and the first bore 1151 of each of the spacing blocks 115, and each screwed into the locking bore 3221 of each of the convex portions 322.

In the preferred embodiment of the present invention, the mounting recess 511 of the circular cap 51 is mounted on and combined with a top of the shaft shank 461 of the central rotation shaft 46 by a locking member 53. The mounting recess 511 of the circular cap 51 is provided with a fitting hole 5111 to allow passage of the locking member 53, and the top of the shaft shank 461 is provided with a positioning stud 4612 to allow screwing of the locking member 53. The shaft shank 461 of the central rotation shaft 46 has a bottom provided with an abutting stub 4613 inserted into the recessed flange 111 of the support base 11. Preferably, the shaft shank 461 of the central rotation shaft 46 has a square shape, and the mounting recess 511 of the circular cap 51 also has a square shape.

In the preferred embodiment of the present invention, the base unit 1 further includes a ball 117 received in the recessed flange 111 of the support base 11 and located between the recessed flange 111 of the support base 11 and the abutting stub 4613 of the shaft shank 461.

In the preferred embodiment of the present invention, the base unit 1, the annular block 2, the cover 3 and the rotary driving unit 5 are made of metallic material that is selected from any one of copper, stainless steel, aluminum, zinc or iron. Thus, the annular block 2 can enhance the whole strength of the base unit 1.

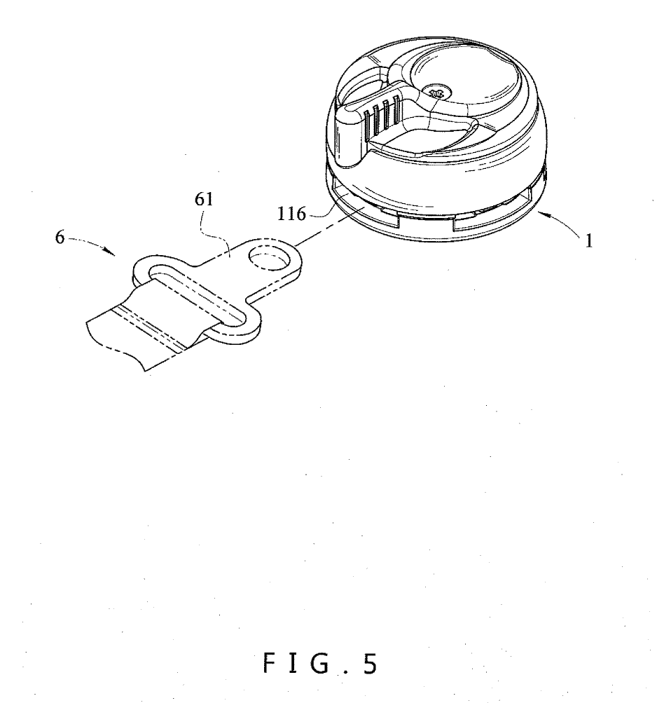

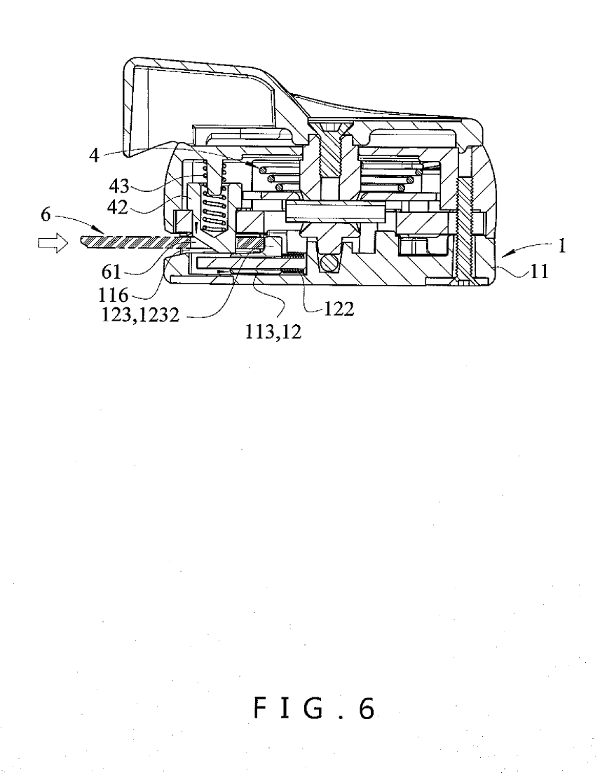

In operation, referring to FIGS. 5 and 6 with reference to FIGS. 1-4, when a latch plate 61 of a safety belt 6 is inserted into one of the insertion slots 116 of the base unit 1, the stop 1232 of the slide 123 of one of the elastic modules 12 is pushed by the latch plate 61 of the safety belt 6 to compress the spring 122, so that the slide 123 is moved in one of the slideways 113 of the support base 11. In such a manner, one of the movable posts 42 of the locking device 4 is released from the stop 1232 of the slide 123 and is pushed downward by the restoring force of one of the springs 43 to lock a hole (not labeled) of the latch plate 61, so that the latch plate 61 of the safety belt 6 is locked by one of the movable posts 42 of the locking device 4 and retained by the slide 123 of one of the elastic modules 12.

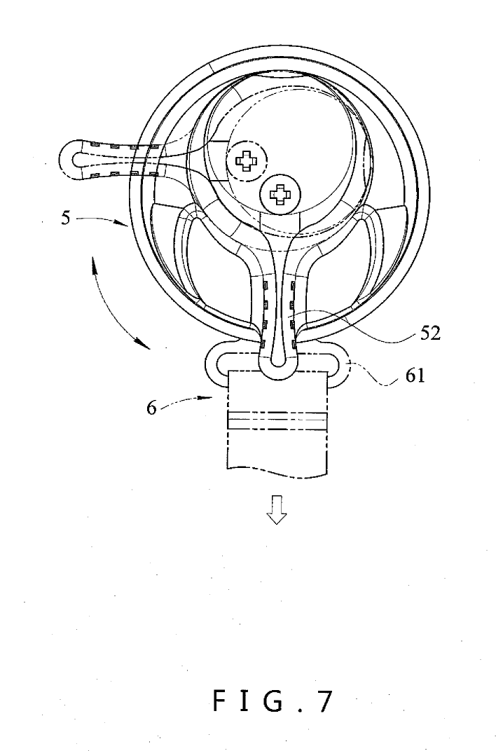

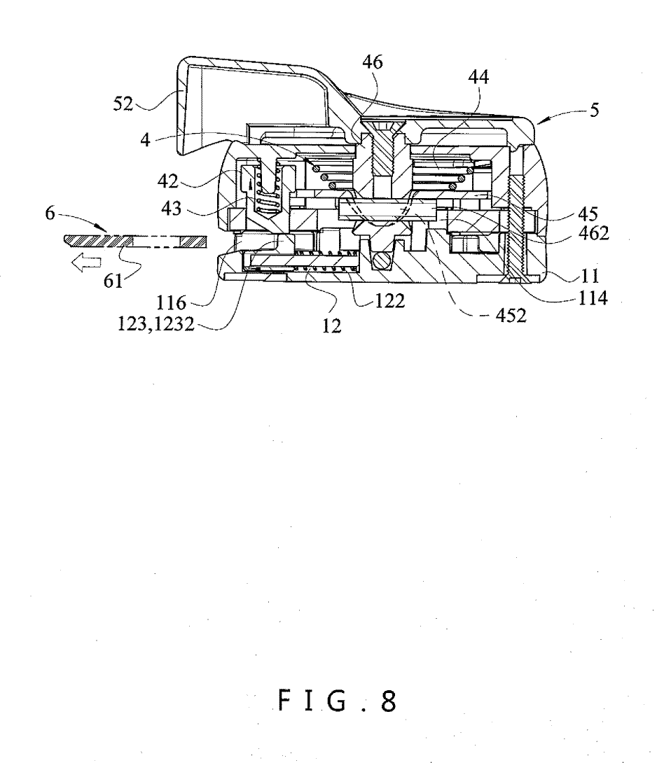

On the contrary, referring to FIGS. 7 and 8 with reference to FIGS. 1-4, when the drive handle 52 of the rotary driving unit 5 is driven, the circular cap 51 of the rotary driving unit 5 is rotated to rotate the central rotation shaft 46 of the locking device 4. At this time, rotation of the central rotation shaft 46 is limited by the abutting pieces 114 of the support base 11. In addition, the pin 462 of the central rotation shaft 46 initially abuts the notch of the hollow lug 452 of the driven plate 45. When the central rotation shaft 46 of the locking device 4 is rotated, the pin 462 of the central rotation shaft 46 is moved toward an edge of the hollow lug 452 to push the driven plate 45 upward and to compress the conical spring 44, so that each of the movable posts 42 of the locking device 4 is moved upward by the driven plate 45, and each of the springs 43 is compressed. In such a manner, the latch plate 61 of the safety belt 6 is unlocked from one of the movable posts 42 of the locking device 4, and is pushed outward by the restoring force of the spring 122, so that the latch plate 61 of the safety belt 6 is detached from one of the insertion slots 116 of the base unit 1.

After the latch plate 63 of the safety belt 6 is released from the base unit 1, the driven plate 45 is pushed by the restoring force of the conical spring 44 to return to the original position; and the slide 123 of one of the elastic modules 12 is also pushed by the restoring force of the spring 122 to return to the original position, so that the stop 1232 of the slide 123 of one of the elastic modules 12 presses one of the movable posts 42 again, and the central rotation shaft 46 and the rotary driving unit 5 are driven to rotate reversely to the original position.

Accordingly, the annular block 2 made of metallic material is combined with the base unit 1 to reinforce the whole strength of the base unit 1, thereby enhancing the safety of using the safety belt buckle.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A safety belt buckle comprising:
a base unit;
an annular block mounted on the base unit;
a cover covering the base unit, a locking device mounted in the cover; and
a rotary driving unit mounted on the cover;
wherein:
the base unit includes:
a support base having a top provided with a plurality of slideways and a bottom provided with an annular groove disconnected from the slideways; and
a plurality of elastic modules mounted in the slideways;
the top of the support base has a center provided with a recessed flange which protrudes outward from the top of the support base;
each of the slideways extends from the recessed flange to a periphery of the support base;
the slideways of the support base are arranged in a radiating manner;
the support base is provided with a plurality of abutting pieces surrounding the recessed flange;
the periphery of the support base is provided with a plurality of spacing blocks and a plurality of insertion slots located between the spacing blocks;
the annular block is mounted in the annular groove of the support base;
the annular block is made of metallic material to enhance a whole strength of the support base of the base unit;
the cover has a top provided with a mounting depression and a bottom provided with a receiving space;
the top of the cover has a center provided with a shaft hole connected to the receiving space;
the receiving space of the cover is provided with a plurality of convex portions, a plurality of concave portions located between the convex portions, and a plurality of pillars located in the concave portions;
the locking device is mounted in the receiving space of the cover and includes:
a fixed post mounted on one of the pillars of the cover;
a plurality of movable posts mounted on the pillars of the cover and corresponding to the elastic modules of the base unit;
a plurality of springs mounted on the pillars of the cover and located in the fixed post and the movable posts;
a conical spring mounted in the receiving space of the cover and corresponding to the shaft hole of the cover;
a driven plate mounted in the receiving space of the cover and abutting the conical spring;
a central rotation shaft mounted on the cover; and
a fixed disk arranged under the driven plate and abutting the spacing blocks of the support base;
the driven plate of the locking device has a central portion provided with a through hole and a hollow lug and has a rim provided with a plurality of clamping grooves;
the hollow lug of the driven plate has a notch;
the central rotation shaft of the locking device includes:
a shaft shank extending through the through hole of the driven plate and provided with a pivot hole; and
a pin extending through the pivot hole of the shaft shank and abutting the hollow lug of the driven plate;
the pin is not pressed by the abutting pieces of the support base when the central rotation shaft is rotated;
the fixed disk of the locking device has a central portion provided with a retaining hole to allow insertion of the abutting pieces of the support base;
the fixed disk of the locking device has a periphery provided with a plurality of passages corresponding to the slideways of the support base;
the fixed disk of the locking device has a rim provided with a plurality of openings;
the fixed post and the movable posts of the locking device extend through the passages of the fixed disk and are clamped in the clamping grooves of the driven plate;
the fixed post of the locking device has an end provided with an interior hole for mounting one of the springs;
each of the movable posts of the locking device has an end provided with an interior hole for mounting one of the springs;
the rotary driving unit is partially received in the mounting depression of the cover and includes:
a circular cap having a bottom center provided with a mounting recess mounted on the central rotation shaft of the locking device; and
a drive handle extending from the circular cap.

2. The safety belt buckle of claim 1, wherein:
each of the elastic modules of the base unit includes:
a push rod;
a slide mounted on the push rod and having a side provided with a stop pressing one of the movable posts; and
a spring mounted on the push rod and biased between the push rod and the slide; and
the slide of each of the elastic modules is provided with an aperture mounted on the push rod.

3. The safety belt buckle of claim 1, wherein the base unit, the annular block and the cover are combined by screwing.

4. The safety belt buckle of claim 3, wherein each of the spacing blocks of the support base is provided with a first bore, the annular block is provided with a plurality of second bores, each of the convex portions of the cover is provided with a locking bore, and the safety belt buckle further comprises a plurality of fastener members each extending through each of the second bores of the annular block and the first bore of each of the spacing blocks, and each screwed into the locking bore of each of the convex portions.

5. The safety belt buckle of claim 1, wherein the mounting recess of the circular cap is mounted on and combined with a top of the shaft shank of the central rotation shaft by a locking member.

6. The safety belt buckle of claim 5, wherein the mounting recess of the circular cap is provided with a fitting hole to allow passage of the locking member, and the top of the shaft shank is provided with a positioning stud to allow screwing of the locking member.

7. The safety belt buckle of claim 6, wherein the shaft shank of the central rotation shaft has a bottom provided with an abutting stub inserted into the recessed flange of the support base.

8. The safety belt buckle of claim 7, wherein the base unit further includes a ball received in the recessed flange of the support base and located between the recessed flange of the support base and the abutting stub of the shaft shank.
